(19) United States
(12) Patent Application Publication
(10) Pub. No.: US 2011/0252277 A1
(43) Pub. Date: Oct. 13, 2011

(54) ELECTRONIC DEVICE WITH DEBUGGING AND SOFTWARE UPDATING FUNCTION

(75) Inventor: SHUANG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/770,788

(22) Filed: Apr. 30, 2010

(30) Foreign Application Priority Data
Apr. 13, 2010 (CN) 201010146289.X

(51) Int. Cl. G06F 11/36

(52) U.S. Cl. 714/38.1; 714/E11.208

(57) ABSTRACT

An electronic device includes a registered jack 45 (RJ45) port, a network card, a universal asynchronous receiver/transmitter (UART), and a chip. The RJ45 port includes two receiving signal pins, two transmitting signal pins, a data transmitting pin, and a data receiving pin. The network card is connected to the two receiving signal pins and the two transmitting signal pins. The UART includes a data receiving pin and a data transmitting pin. The data transmitting pin is connected to the data receiving pin. The data receiving pin pin is connected to the data transmitting pin. The chip is connected to the UART. The UART is operable to debug or software-update the chip according to signals transmitted through the data transmitting pin and the data receiving pin.

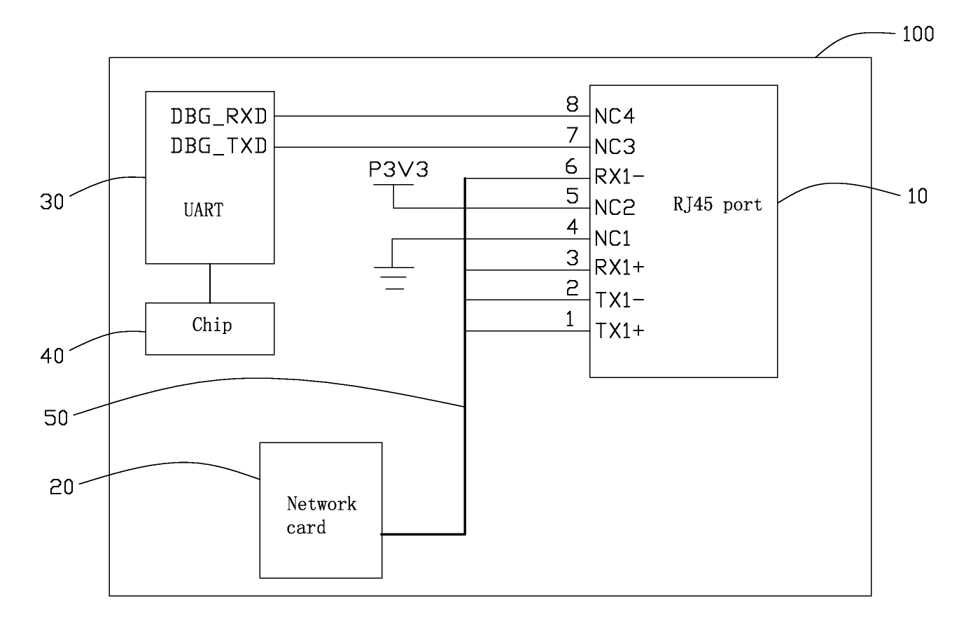

### BACKGROUND

1. Technical Field

The present disclosure relates to an electronic device having a chip which can perform debugging and software updates.

2. Description of Related Art

When a computer chip or other components in an electronic device fails or malfunctions, the device may be rendered unusable or the chip or component must be replaced. Alternatively, the chip could be debugged or have its software updated. A common method to debug or software-update the chip is to connect the chip to a serial interface, and then an external debugging host is connected to the serial interface. Therefore, the debugging host can communicate with the chip via the serial interface, and can debug or software-update the chip. However, a dedicated serial interface may be underutilized because the need for either debugging or software-updating may be infrequent on even non-existent.

### BRIEF DESCRIPTION OF THE DRAWING

Many aspects of the present embodiments can be better understood with reference to the following drawing. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

The drawing is a circuit diagram of an electronic device.

### DETAILED DESCRIPTION

The disclosure is illustrated by way of example and not by way of limitation in the figures of the accompanying drawing in which like references indicate similar elements. It should be noted that references to “an” or “one” embodiment in this disclosure are not necessarily to the same embodiment, and such references mean at least one.

Referring to the drawing, an embodiment of an electronic device 100 includes a registered jack 45 (RJ45) port 10, a network card 20, a universal asynchronous receiver/transmitter (UART) 30, and a chip 40 which may need to be debugged or software-updated from time to time. For example, the chip 40 may contain firmware.

The RJ45 port 10 includes eight pins 1-8, and the definition of the eight pins 1-8 is shown below:

| Pin | Name | Description |
|---|---|---|
| 1 | TX1+ | Receiving signal pin |
| 2 | TX1− | Receiving signal pin |
| 3 | RX1+ | Transmitting signal pin |
| 4 | NC1 | Ground pin |
| 5 | NC2 | Power pin |
| 6 | RX1− | Transmitting signal pin |
| 7 | NC3 | Data transmitting pin |
| 8 | NC4 | Data receiving pin |

Pins 1, 2, 3, 6 are used for network transmission by the electronic device 100. Pins 4, 5, 7, 8 are used for debugging or software-updating of the electronic device 100.

Pins 1, 2, 3, 6 are connected to the network card 20 via a bus 50. When the electronic device 100 works in a normal status, an external network (not shown) can communicate with the network card 20 as long as the external network is connected to the RJ45 port 10 via a network cable (not shown).

Pin 4 is grounded. Pin 5 is connected to a voltage terminal P3V3 to receive a voltage, such as 3.3 volt (V). Pin 7 is connected to a data transmitting pin DBG_TXD of the UART 30. Pin 8 is connected to a data receiving pin DBG_RXD of the UART 30. The chip 40 is connected to the UART 30. When the electronic device 100 is in need of debugging or software-updating, an external debugging host (not shown) is connected to the RJ45port 10 via a network cable (not shown), then the external debugging host can debug or software-update the chip 40 via the UART 30. In one embodiment, pins 4 and 5 is used for providing a ground signal and a power signal to the external debugging host. In other embodiments, if the external debugging host includes a ground signal and a power signal by itself, pins 4 and 5 can be not used. Because the RJ45 port 10 can be used for both normal network communication and for debugging or software-updating, the need for a serial interface dedicated to such processes is eliminated, thus reducing costs of the electronic device as well as saving space in the device in aid of further miniaturization if desired.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An electronic device comprising:
a registered jack 45 (RJ45) port comprising two receiving signal pins, two transmitting signal pins, a data transmitting pin, and a data receiving pin;
a network card connected to the two receiving signal pins and the two transmitting signal pins, wherein the network card operable to receive network signals from the two receiving signal pins and the two transmitting signal pins;
a universal asynchronous receiver/transmitter (UART) comprising a data receiving pin and a data transmitting pin, wherein the data transmitting pin is connected to the data receiving pin, the data receiving pin is connected to the data transmitting pin; and
a chip connected to the UART, wherein the UART operable to debug or software-update the chip according to signals transmitted from the data transmitting pin and the data receiving pin.

2. The electronic device of claim 1, wherein the RJ45 port further comprises a ground pin and a power pin, the ground pin is grounded, the power pin is connected to a voltage terminal.

3. The electronic device of claim 1, wherein the chip contains firmware.
